(19) United States
(12) Patent Application Publication
(10) Pub. No.: US 2006/0122873 A1
(43) Pub. Date: Jun. 8, 2006

(54) Method and system for managing risk

(76) Inventor: Francis John Minotto, Douglassville, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/199,477

(22) Filed: Aug. 8, 2005

Related U.S. Application Data
(60) Provisional application No. 60/615,513, filed on Oct. 1, 2004.

(51) Int. Cl. G06F 9/44

(52) U.S. Cl. 705/7

(57) ABSTRACT

A system for managing risk includes a user interface enabling selection of a particular affected entity from a plurality of predetermined types of affected entities, in response to a user command. A repository includes information associating the selected affected entity with a particular hazard potentially adversely affecting the selected affected entity. The information in the repository associates the particular hazard with: a severity of the particular hazard; a cause of the particular hazard; and a probability of occurrence of the cause. A risk processor uses information from the repository to provide an indication of risk of the particular hazard to the affected entity.

This is a non-provisional application of provisional application Ser. No. 60/615,513 filed Oct. 1, 2004, inventor Francis John Minotto.

### FIELD OF THE INVENTION

The present invention relates generally to the field of risk management, and more specifically to a method and system for managing the risks in the development of entities by means of a management process.

### BACKGROUND OF THE INVENTION

Risk management relates to a process for determining if a potential hazard to an entity such as a device or process exists and, if so, whether corrective or mitigating action is necessary. A hazard is a source of danger or a potential source of harm, where harm is defined as a “physical injury or damage to the health of people, property, or the environment.” A hazard has both an absolute value of severity and an absolute probability of occurrence. The combination of severity and the probability of occurrence constitute risk. The risk manager decides if the risk presented by the hazard is acceptable or unacceptable. If the risk is unacceptable, the risk manager takes action to reduce the effect of the risk by reducing the severity, by reducing the probability, or by reducing both items.

A risk management process for medical devices is mandated both in the United States and other countries. The Food and Drug Administration as well as the European Union require this effort for both hardware and software systems that are designated as medical devices. One current standard for that effort is set forth in a document published by the International Organization for Standardization (ISO) entitled “ISO 14971:2000, Medical Devices—The Application of Risk Management to Medical Devices”. Other standards exist as well.

In performing risk management using existing systems, analysts typically store results and cross references by means of paper documentation. Analysts need access to the documentation in order to possess the relevant information. However, paper documentation may not include the latest requirements, hazards, mitigations, test plans, and test results. Getting approval for paper documentation and the storage of that documentation is time consuming and can produce errors in cross referencing. Existing systems are manually intensive and require additional resources that are dedicated to managing the paper documents. A system constructed according to the principles or the present invention addresses these deficiencies and their related problems.

### BRIEF SUMMARY OF THE INVENTION

In accordance with principles of the present invention, a system for managing risk includes a user interface enabling selection of a particular affected entity from a plurality of predetermined types of affected entities, in response to a user command. A repository includes information associating the selected affected entity with a particular hazard potentially adversely affecting the selected affected entity. The information in the repository associates the particular hazard with: a severity of the particular hazard; a cause of the particular hazard; and a probability of occurrence of the cause. A risk processor uses information from the repository to provide an indication of risk of the particular hazard to the affected entity.

### BRIEF DESCRIPTION OF THE DRAWING

In the drawing:

FIG. 1 is a block diagram of the present invention;

FIG. 2 is a flow chart depicting the relationship between requirements management and risk management as utilized by the present invention;

FIG. 3 is a flow chart depicting the function of risk management during product implementation and testing as implemented by the present invention;

FIG. 4 is a flow chart depicting the processing of stakeholder requests by the migration and convergence application as illustrated in FIG. 3;

FIG. 5 is a flow chart depicting a first embodiment of the analysis of the probability and severity of a hazard as performed by the risk processor illustrated in FIG. 1;

FIG. 6 is a flow chart depicting a second embodiment of the hazard probability and severity analysis performed by the risk processor illustrated in FIG. 1;

FIG. 7 depicts a first Graphical User Interface implemented by the present invention;

FIG. 8 depicts a second Graphical User Interface implemented by the present invention;

FIG. 9 depicts a third Graphical User Interface implemented by the present invention;

FIG. 10 depicts a fourth Graphical User Interface implemented by the present invention;

FIG. 11 depicts a fifth Graphical User Interface implemented by the present invention;

FIG. 12 depicts a sixth Graphical User Interface implemented by the present invention;

FIG. 13 depicts a seventh Graphical User Interface implemented by the present invention;

FIG. 14 depicts an eighth Graphical User Interface implemented by the present invention;

FIG. 15 depicts a ninth Graphical User Interface implemented by the present invention;

FIG. 16 depicts a tenth Graphical User Interface implemented by the present invention

FIG. 17 depicts an eleventh Graphical User Interface implemented by the present invention; and

FIG. 18 is a block diagram of a computer system on which the risk management system according to the present invention may be implemented.

### DETAILED DESCRIPTION OF THE INVENTION

As used herein, a processor operates under the control of an executable application to (a) receive information from an input information device, (b) process the information by manipulating, analyzing, modifying, converting and/or transmitting the information, and/or (c) route the information to an output information device. A processor may use, or comprise the capabilities of, a controller or microprocessor, for example. The processor may operate with a display processor or generator. A display processor or generator is a known element for generating signals representing display images or portions thereof. A processor and a display processor comprises any combination of, hardware, firmware, and/or software.

An executable application as used herein comprises code or machine readable instructions for conditioning the processor to implement predetermined functions, such as those of an operating system, risk management system, healthcare information system or other information processing system, for example, in response user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A user interface comprises one or more display images, generated by the display processor under the control of the processor, enabling user interaction with a processor or other device.

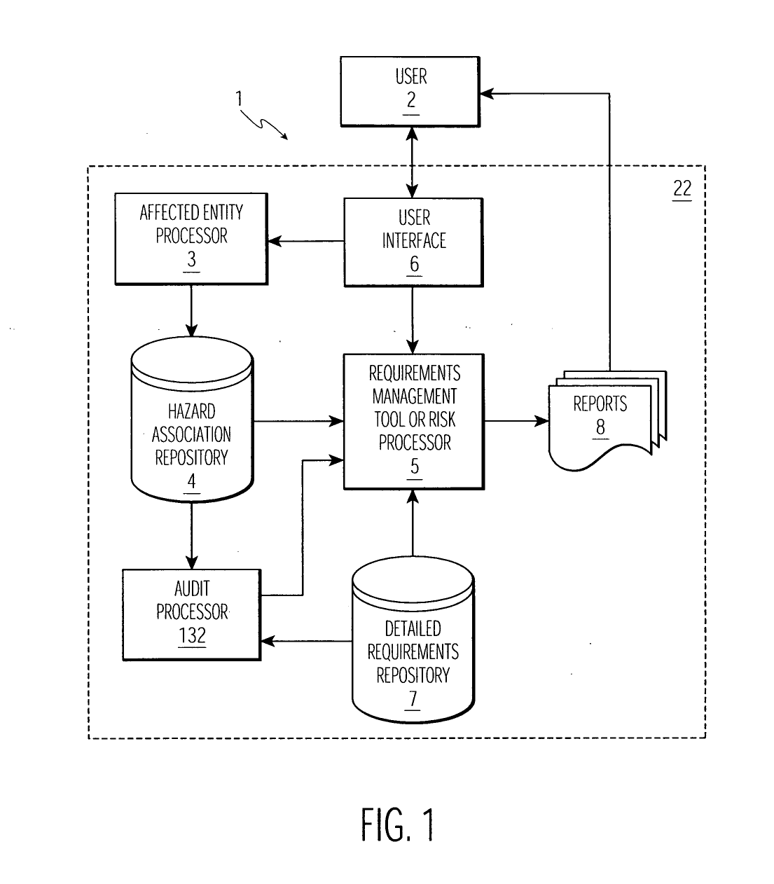

The risk management system of the present invention is illustrated in block diagram form in FIG. 1. The risk management system 1 is integrated into a quality management system 22 which is a process useful in the product, project and market development process. The risk management system 1 includes a user interface 6 that comprises information representing one or more display images enabling a user 2 to interact with an affected entity processor 3 and a risk processor 5. In response to a command from the user, a particular affected entity may be selected from among a plurality of such entities managed by the affected entity processor 3. The affected entity selected may be one of a plurality of types of entities, for example, (a) a project, (b) a product, (c) a market, (d) a product feature, or (e) a set of product features. In a medical care context a type of an affected entity may be, for example, a patient environment. Another specific example of a type of an affected entity in a traffic engineering context is a highway tunnel.

Once an affected entity has been selected by the user 2, information representing the identity of the selected affected entity is forwarded to a hazard association repository 4. The hazard association repository 4 contains information associating affected entities with particular hazards that potentially adversely affect the entity. The hazard association repository 4 associates a particular hazard with various characteristics of the hazard, such as the severity of the hazard, the cause or causes of the hazard and the probability of occurrence of at least one of the possible causes. In the case of a highway tunnel, for example, one particular hazard is the danger of an explosion occurring within the tunnel, which could be very severe. Such an explosion may be caused, for example, by the transport of explosive materials through the tunnel in a vehicle. The probability that such a vehicle may approach the tunnel as part of daily or weekly traffic flow can be calculated.

It is also possible that a plurality of hazards exists potentially adversely affecting the selected affected entity. The hazard association repository 4 may also associate the respective individual hazards of the plurality of hazards with various characteristics of the hazard, such as the severity of the hazard, the cause or causes of the hazard and the probability of occurrence of at least one of the possible causes, as described above.

The hazard related information, retrieved by the hazard association repository 4 in response to the identification of the affected entity selected by the user 2, is forwarded to the risk processor 5. That is, the risk processor 5, in response to the information from the hazard association repository 4, provides an indication of the risk that a particular hazard poses to the selected affected entity. In the case where a plurality of hazards is associated with the selected affected entity, the risk processor 5 is able to provide indications of risk of the respective individual hazards to the affected entity and is further able to rank individual hazards according to their indications of risk.

The risk processor 5 also is coupled to a detailed requirements repository 7, which contains, among other things, information that indicates whether mitigation is necessary for the particular hazard identified. In the case of the previously mentioned highway tunnel, an example of mitigation of the explosion hazard within the tunnel may include the existence of regulations that prohibit the transport of explosive materials within a tunnel. An additional act of mitigation in that case may be the posting of signs at the tunnel approach and entrance notifying drivers that explosive material may not be transported through the tunnel. The hazard association repository 4 further includes information associating a particular hazard with one or more tests that may be used to verify that the particular hazard has been mitigated. The detailed requirements repository 7 also contains information associating the particular hazard with the residual severity remaining after mitigation of the particular hazard has been accomplished. The detailed requirements repository 7 further contains information associating the particular hazard with an indication that the particular hazard has been mitigated and identifying a person responsible for the mitigation.

The risk processor 5 can determine from the information in the detailed requirements repository 7 whether a particular hazard requires mitigation. It can also provide information related to a test to determine whether the hazard has been mitigated, the residual severity of the hazard after mitigation, and the person responsible for mitigating the hazard. The risk processor 5 may prepare reports 8 based on this information. The reports 8 are supplied to the user 2 to monitor the status of the affected entities, the hazards and risks associated with them, any mitigations performed on the affected entities, and residual risk remaining after mitigation, among other information.

The system 1 also includes an audit processor 132 which monitors access initiated by the user 2 to the hazard association repository 4 and the detailed requirements repository 7 and records data indicating the particular information accessed and identifying the particular user 2 who initiated the access. The audit processor 132 also monitors modifications made to information stored in the repositories 4 and 7, and records data indicating the modifications made and the identify of the source processing device that originated the message causing or otherwise initiating the data modification. The risk processors retrieves data from the audit processor 132 and generates reports 8 that embody an audit trail documenting the foregoing actions. The reports 8 are supplied to the user 2 to monitor access to the repositories 4 and 7 and modifications to the information stored in them.

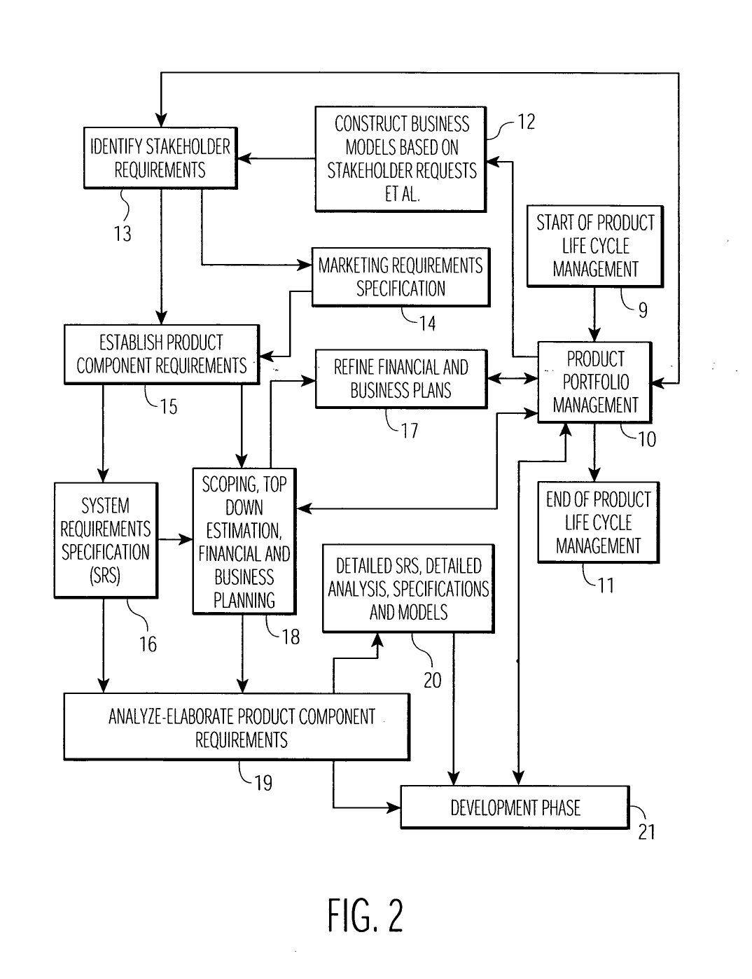

FIG. 2 is a flowchart which illustrates that requirements management and risk management are interrelated and shows ongoing activities occurring throughout particular product and/or project life cycles. In FIG. 2, to simplify the figure and the associated written description, below, reference is made to a product life cycle. One skilled in the art understands that the illustrated steps also apply to project life cycles. Throughout the steps illustrated in FIG. 2, a product management team may discover potential hazards based on the development of that product.

The start of the product life cycle management process, block 9, causes the initialization of a product portfolio management function in block 10. The first step in block 12 is for a requirements management team to construct business models based on business needs and stakeholder requests (SRQs), relying on the scenarios envisioned to create an initial business and financial plan. As described above, even at first step in block 12 the requirements management team can uncover potential hazards based on the stakeholder requests. Based on the stakeholder requests determined in block 12, stakeholder requirements are initially identified in block 13. These may be updated at any time while performing the product portfolio management function 10. Once stakeholder requirements are identified in block 13, marketing requirements may be defined in block 14, and placed in a marketing requirements specification, which together with the stakeholder requirements are used to establish product and product component requirements in block 15. System requirements may be defined in block 16 and placed in a system requirements specification (SRS) which may include information generated by hazard, compliance and regulatory analysts. The SRS produced in block 16 serves as the basis for defining the scope and estimating the cost of the product in block 18 along with the product and product component requirements from block 15. The information related to the scope and cost of the product management process, generated in block 18, may be used to refine the financial and business plans in block 17. The refined financial and business plan as generated in block 17 is then integrated into the overall portfolio management process 10. The portfolio management function 10 is able to interact directly with the requirements team throughout the process of defining the scope and estimating the cost of the product in block 18.

Once the SRS is determined in block 16 and the scope and cost of the product are defined in block 18, an analysis and elaboration function is performed in block 19 to examine the product and product component requirements. The analysis-elaboration function in block 19 permits the requirements team to determine if any additional hazards have become apparent based on additional and updated information. Based on the results of the analysis-elaboration function in block 19, a more detailed SRS is created at step 20 which contains detailed analyses, specifications and models. The completion of the functions in blocks 19 and 20 permit the product to enter the development phase 21, at which time a product development team addresses the previously identified hazards, and generates requirements for mitigation needed in view of the identified hazards. Once the development phase of block 21 is complete, and the development team has completed testing and validation to verify appropriate mitigation of identified hazards, the portfolio management function 10 can affirm that the end 11 of the product life cycle management function has been reached.

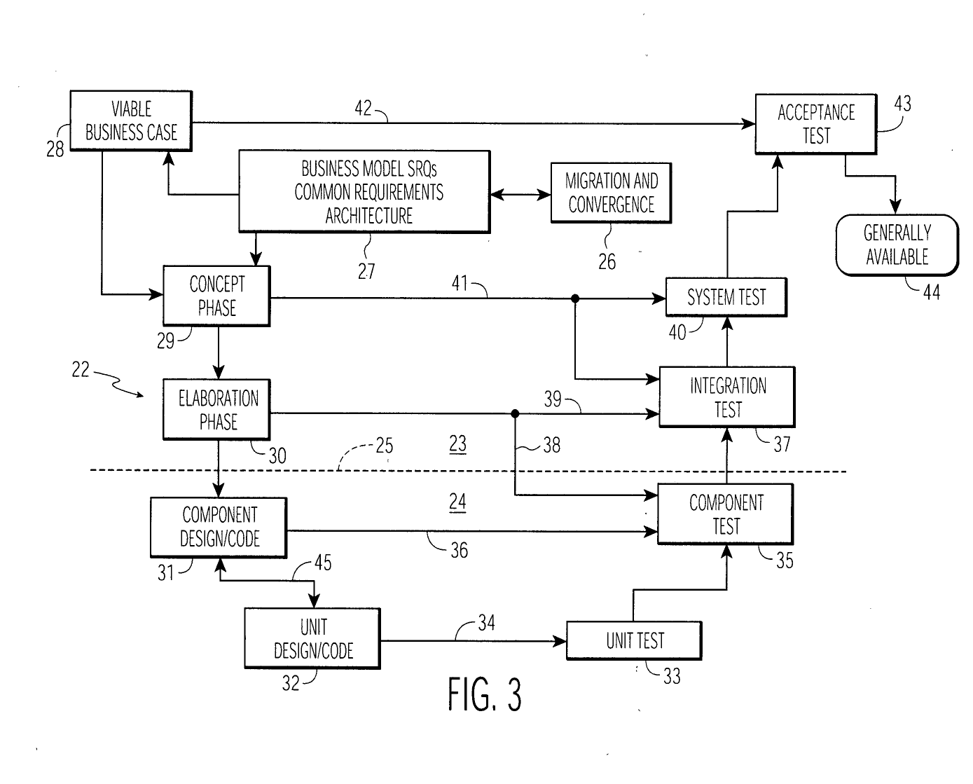

FIG. 2 illustrates the interrelationship between the requirements management and hazard-risk analysis functions. FIG. 3 illustrates more specifically how the quality management system (QMS) 22 of the present invention performs the hazard-risk management steps from product pre-conception through the product final testing phase. The QMS 22 contains the process steps for implementing hazard-risk assessment and analysis.

A pre-concept phase of product development includes several subprocesses or procedures. A subprocess 27 is the construction of business models based on various business scenarios. The business model incorporates stakeholder requests (SRQs) and defines a common requirements architecture. Throughout the pre-concept phase, the information created during the business model construction subprocess 27 is analyzed by the migration and convergence subprocess 26 to verify that a product has been properly defined and analyzed. More specifically, in the illustrated embodiment, the migration and convergence subprocess 26 analyzes stakeholder requests to determine whether those requests should be incorporated into the product.

The information from the migration and convergence subprocess 26 is fed back to business model construction subprocess 27 to permit refinement of the business model which is then analyzed by a subprocess 28 to verify that a viable business case has been created. As part of this process, potential hazards may be identified. The team assigned to execute the QMS 22 can, at this time, identify hazards and create hazard entries containing data representing that hazard. Such hazard entries are stored in the hazard association repository 4 (FIG. 1). Status information is included in the hazard entries indicating that additional work is necessary during the subsequent concept phase if the project is eventually launched. While gathering stakeholder requests (SRQs) the QMS 22 can be used to uncover and track potential hazards. The QMS 22 also stores, in the hazard association repository 4, data representing the stakeholder requests associated with hazard entries. In addition, the causes of the hazard might be evident. The QMS 22 can also store, in the hazard association repository 4, data representing causes for the respective hazards, if they are known. Once the concept phase starts, additional analysis can refine these initial assessments.

During a concept phase 29 features of the target product or system are specified. As before, hazards may be determined at this phase as well. The assistance of subject matter experts and other analysts such as hazard, compliance, and regulatory analysts can be used to perform the risk management process that determines particular hazards and their causes. Data representing the identified hazards are stored in the hazard association repository 4 (FIG. 1). This information is forwarded to the risk processor 5 for analysis. Typical analysis techniques utilized are failure mode and effects analysis (FMEA) or fault tree analysis (FTA).

The concept phase 29 is followed by an elaboration phase 30, which determines if additional hazards are identified. Documentation is completed for causes of the identified hazards and corresponding mitigations that may be required. The QMS 22 accesses a risk matrix that indicates, for a given pairing of hazard severity and probability, a resultant value of risk tolerance. During elaboration phase 30 a determination is made if mitigation is necessary for intolerable risks or, alternatively, if a change to the proposed system or solution is necessary to reduce those risks where mitigation is not possible.

At the end of the elaboration phase 30, significant hazards and their causes have typically been identified and mitigated. A traceable record exists originating with mitigated causes of harm to the requirements or actions that perform the required mitigation. If mitigation has occurred, a determination of the severity and probability of the residual hazard can be made.

The elaboration phase 30 is followed by a product development phase, beginning with a subprocess 31 during which executable procedures, components and other software and/or hardware are designed. Design and coding at the unit level occurs during subprocess 32. During steps 31 and 32 the development team addresses the previously identified mitigation requirements, and refinement of the identified mitigation requirements may occur between subprocesses 31 and 32 along the iterative path 45. That is, mitigations identified in previous subprocesses may be designed and implemented in the executable procedures, components and other software and/or hardware developed in subprocesses 31 and 32. In addition, the analysis of hazards continues to ensure that no additional hazards are created during design and coding. The steps 26 through 32 define the risk management activities associated with a product.

The development phase continues with product testing. The unit level verification data are supplied to the unit test level 33 via path 34. The developed executable procedures, components and other software and/or hardware are tested to ensure they meet the comply with the verification data in the unit test level 33. Component verification data 36 and elaboration phase verification data 38 are utilized to perform component tests 35. The component tests 35 ensures that the developed executable procedures, components and other software and/or hardware comply with the verification data 36 and 38 from the component design subprocess 31 and the elaboration phase 30, respectively.

The region 24 below line 25 contains those tasks that are based on the performance of the actual component and unit hardware and software of which the final product is composed. The tasks in region 23 represent the verification of system goals based on the performance of the unit and component hardware and software operating together as a system. Thus the next test is the integration test 37, followed by the system test 40 and the acceptance test 43. The testing team explicitly designs each test to include verification of the previously defined mitigation requirements, as indicated by verification paths 39, 41 and 42, respectively.

More specifically, in the integration test 37 of the illustrated embodiment, the operation of the product or system is tested to ensure that it satisfies verification data 39 and 41 from the elaboration phase 30 and concept phase 29, respectively. Similarly, in the system test 40, the product or system is tested to ensure that it satisfies verification data 39 and 41 from the concept phase 29; and in the acceptance test 43, the product or system is tested to ensure that it satisfies business model verification data 42 from the business model verification process 28. Once the acceptance test 43 is successfully completed, the product or system achieves a generally available status 44. The steps 33 through 44 define the verification or validation of risk control activities associated with a product. The validation functions address the actual hazards that were mitigated to ensure that the mitigation was in fact successful.

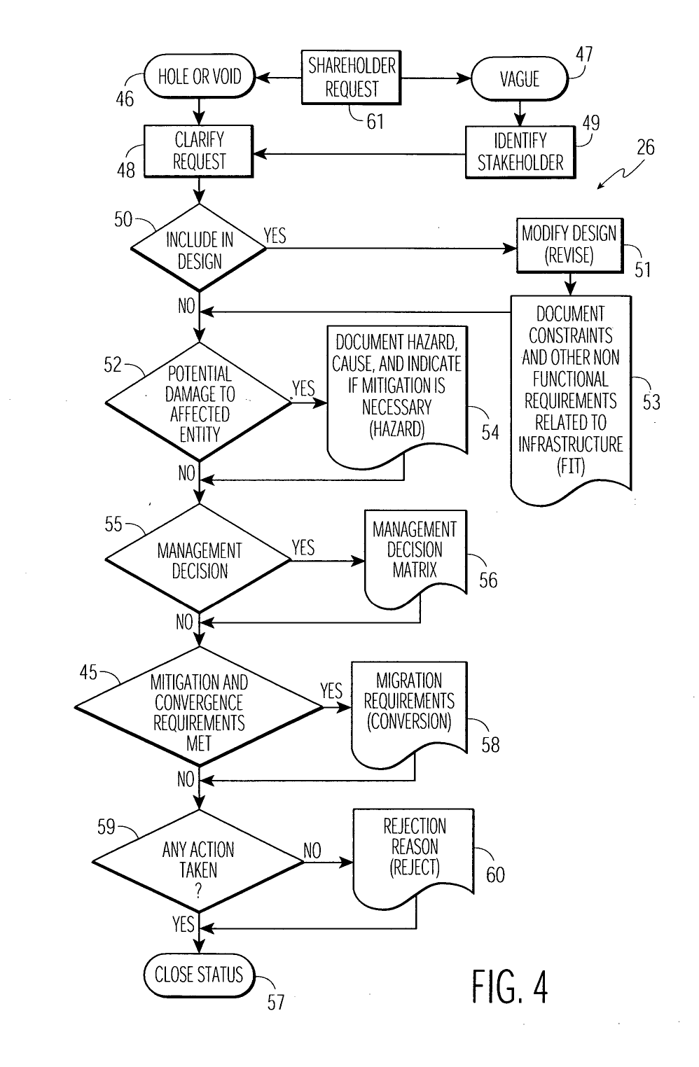

The function of the migration and convergence subprocess 26 is described in more detail with reference to FIG. 4. Each stakeholder request (SRQ) 61 is analyzed to determine its state of clarity and completeness. If the SRQ 61 is ambiguous, the SRQ is categorized as having a vague state in step 47. Vague SRQs 61 are forwarded to the stakeholder identifier 49, which identifies the stakeholder which generated the request, and requires the identified stakeholder to clarify the SRQ at step 48. If an SRQ 61 identifies a gap or missing information in the proposed product or system and/or its associated architecture, the SRQ is assigned a void state in step 46. SRQs having a void state are also required to be clarified at step 48 by an entity having the necessary information.

Once a clear and complete SRQ 61 is received, a decision is made at step 50 as to whether or not the SRQ is to be included as a feature of the product. If the decision in step 50 is negative, the unmodified system design is examined at step 52 to determine if the design poses a potential for damage to the affected entity. If the decision in step 50 is affirmative, the product design is modified or revised at step 51. Constraints and nonfunctional requirements, related to infrastructure, of the design are documented in step 53. The documentation step 53 ensures that the modified design fits into the overall product or system infrastructure. The documentation produced at step 53 is also examined at step 52 to determine if it may be a cause of potential damage to the affected entity.

If, in step 52, the system design is not found to include a risk of damage, the design information is forwarded to the management team at step 55. If the project or product design does appear to include a risk of damage, the specific hazard, its cause and the need for mitigation is documented as part of the hazard report in step 54. The hazard report is also forwarded to the management team for its consideration at step 55. The management team decides at step 55 if the product design needs further modification. If the product is to retain its original, unmodified design, the design advances to step 45 which determines if migration and convergence requirements are met. If the management team decides that product revision is appropriate, the revised product features are entered into a management decision matrix in step 56. The design matrix is examined at step 45 to determine adherence to migration and convergence requirements.

In the event that the product or system design does not satisfy migration and convergence requirements, the decision is made at step 59 to determine if any further action is to be taken regarding the SRQ 61. If migration and convergence requirements are met, the documentation of the migration requirements occurs at step 58, with the requirements documentation being forwarded to step 59 for a determination of what action is to be taken. If the project is to continue, the status of the inquiry performed by subprocess 26 (FIG. 3) is closed at step 57. If no further action is to be taken, the reason for the rejection of the SRQ 61 is documented at step 60 and then the status of the subprocess 26 inquiry is closed at step 57.

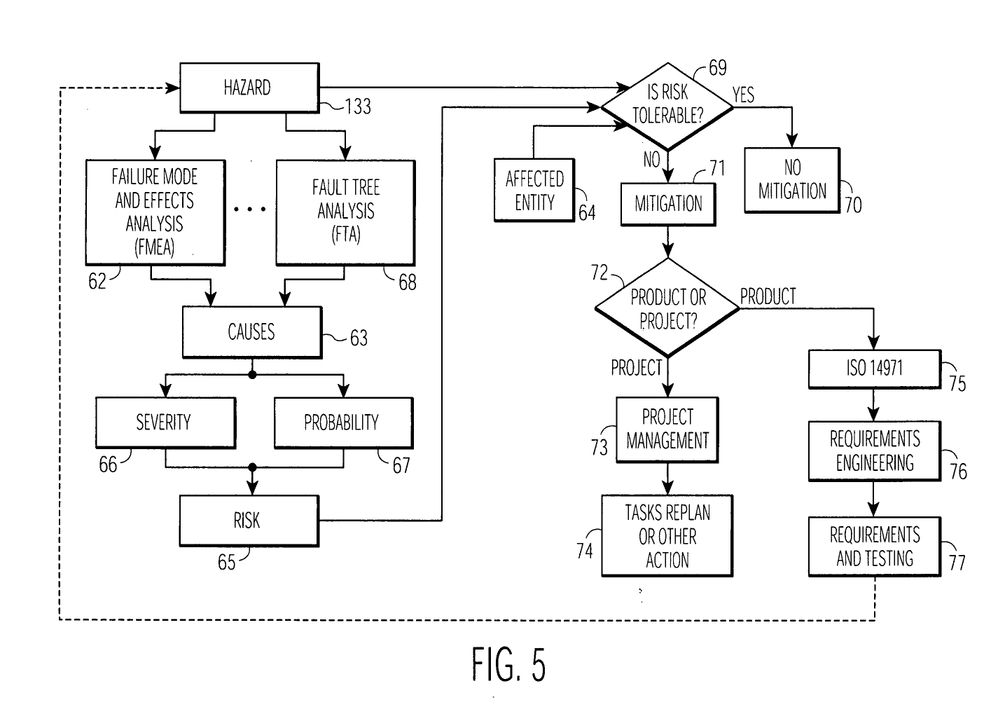

The function of the risk processor 5 (FIG. 1) can be better understood with regard to performing the analysis of the probability and severity of hazards, and to evaluating how the mitigation of intolerable risks affects the project plan as well as product development and testing by referring to FIG. 5. The analysis begins in step 133 with the identification of a hazard, a hazard being defined as a potential source of harm to an affected entity. The hazard identified in step 133 is subjected to at least one of potentially several different forms of hazard analysis. More specifically, in the illustrated embodiment, a first such analysis is a failure mode and effects analysis (FMEA) in step 62 and a second is a fault tree analysis (FTA) in step 68. The result of one or both of these analyses produces a set containing at least one cause which is identified in step 63. A cause is defined as a foreseeable event or sequence of events that could generate a hazardous situation.

The causes identified in step 63 are subjected to a severity analysis in step 66 and a probability analysis in step 67. The results of the severity analysis and probability analysis in steps 66 and 67, respectively, are further analyzed in step 65 to calculate an absolute risk value. In general, the risk of the hazard 133 is dependent on the respective severities 66 and probabilities of occurrence 67 of the causes 63. For example, a composite severity dependent on the respective severities of the causes 63, and a composite probability dependent on the respective probabilities of occurrences of the causes 63 may be assigned to the hazard 133. In this example, the absolute risk 65 may be calculated based on the composite severity and probability of the hazard 133. Alternatively, the respective severity 66 and probability 67 of the causes 63 may be analyzed separately to generate an absolute risk value in step 65.

The effect of the risk value is dependent on the identity of the affected entity 64, and both the risk value determined in step 65 and the hazard from step 133. The risk value from step 65, the type of the affected entity from step 64 and information representing the hazard from step 133 are processed to create a value of risk tolerance in step 69. If the risk is tolerable, the analysis ends with a decision in step 70 that no mitigation is necessary. If the risk is not tolerable, the appropriate information is forwarded to the mitigation analysis subprocess, illustrated as initiating in step 71, for additional analysis.

The first step 72 in the mitigation analysis is to determine whether the affected entity is a project or a product. If the affected entity type is a project, the appropriate hazard data is forwarded to the project management team 73 which may revise the project accordingly at process step 74 by, for example, revising the project plans, performing project related tasks, or taking other appropriate action. If the affected entity is a product, the hazard information is analyzed according to the relevant standards for that product. For example, in the case of a medical device, the hazard information is subjected to ISO 14971 analysis in step 75. Based on the particular requirements of the ISO 14971 standard as applied to the hazard from step 133, the standards to be met are forwarded to the requirements engineering team in step 76, which formulates a requirements and testing program in step 77.

After mitigation has been performed for the identified hazard to the affected entity, that hazard may be reanalyzed. This is indicated in phantom in FIG. 5. The hazard identified in 133 is reanalyzed by the FMEA 62 and/or FTA 68 to generate a revised set of causes 63. The severity and probability of the revised set of causes 63 are determined (66, 67) and the post-mitigation risk calculated (65). The resulting post-mitigation risk is checked in 69 to determine if that risk is tolerable. If it is, then further mitigations are defined in step 71, as described above.

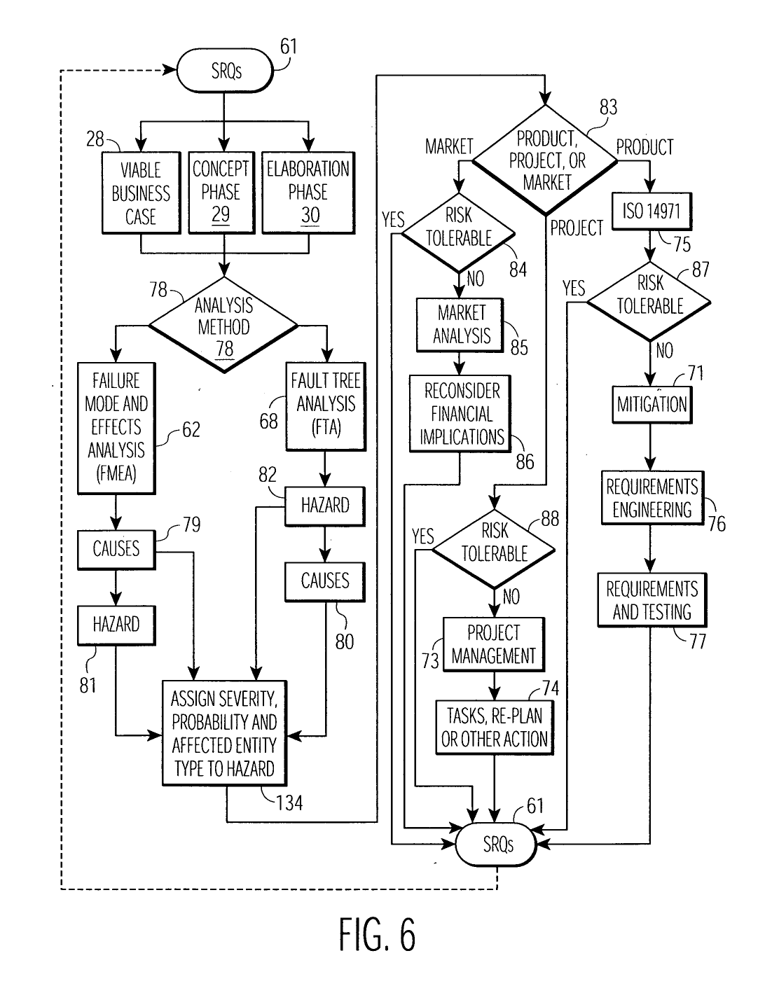

The risk processor 5 (FIG. 1) is also capable of processing and analyzing hazard information in alternate ways. A second embodiment of the function risk processor 5 is illustrated in FIG. 6, in which SRQs 61 are concurrently forwarded to the viable business case subprocess 28 (FIG. 3), the concept phase subprocess 29 and the elaboration phase subprocess 30. Each of the subprocesses 28, 29 and 30 forwards the information produced, and in particular the information related to risks, to step 78 which selects one of potentially several modes of hazard analysis. More specifically, in the illustrated embodiment, step 78, may select either a fault tree analysis (FTA) in step 68 or a failure mode and effects analysis (FMEA) in step 62.

The FMEA analysis 62 associates potential causes represented by block 79 to a corresponding hazard represented by block 81, while the FTA analysis 68 associates a hazard represented by block 82 with corresponding potential causes represented by block 80. The respective causes (79, 80) and hazards (81, 82) generated by analysis methods 62 and/or 68, respectively, are supplied to step 134. In step 134 a hazard severity and a probability of occurrence to an affected entity type is associated with each hazard 81, 82. In addition, a value, representing the risk that the hazard 81, 82 poses to the affected entity type, is calculated. In the illustrated embodiment, the affected entity type is identified as one of a market, project and product at step 83. Regardless of the affected entity type, a finding, in steps 84, 87 and 88, that the risk is tolerable results in that information being associated with the underlying SRQ 61 as an acceptable risk requiring no further action.

If, in step 83, the affected entity type is a market and the risk is determined at step 84 to be intolerable, a market analysis is performed in step 85 and the results are reexamined from a financial standpoint at step 86. The results of the financial reconsideration from step 86 are returned for association with the underlying SRQ 61. If the affected entity type is a product, then a relevant standard related to that product is consulted to determine an acceptable risk tolerance level. More specifically, in the illustrated embodiment, if the affected entity type is a medical product, the hazard information is compared to the relevant standard, ISO 14971, in step 75 to determine the tolerable risk level. If the risk is found to be intolerable at step 87, the hazard information enters a mitigation subprocess at step 71. The mitigation subprocess 71 produces mitigation recommendations which are forwarded to the requirements engineering subprocess in step 76. The requirement engineering subprocess 76 generates mitigation requirements which are supplied to a requirements specification and testing phase in step 77. The results of the testing phase 77 are then associated with the underlying SRQ 61. If the affected entity is a project and the risk is determined to be intolerable at step 88, the hazard information is supplied to a project management subprocess in step 73. The project management subprocess 73 produces a set of revised plans, tasks or other appropriate courses of action in step 74 which are associated with the original SRQ 61. As described above with respect to FIG. 5, hazards may be reanalyzed to verify that the resulting post-mitigation risks are acceptable.

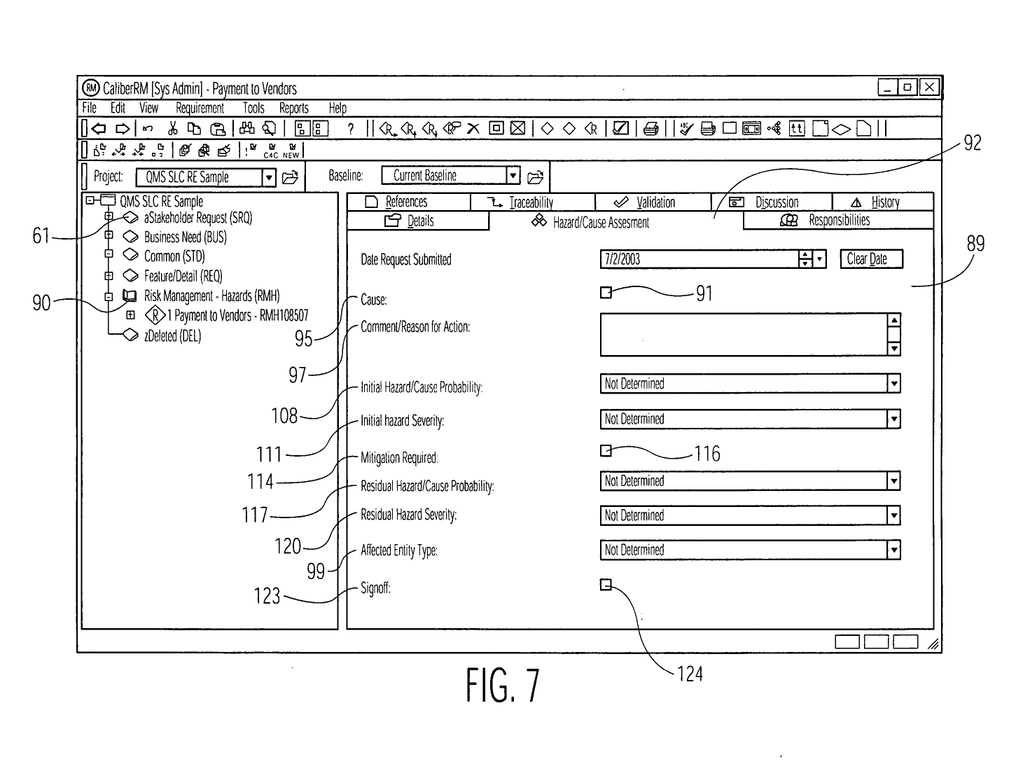

An example of an embodiment may be understood with reference to FIG. 7 through FIG. 17, which illustrate various graphical user interface (GUI) display images that may be used in conjunction with a requirements management executable application. One example of such an executable application is the CaliberRM product of the Borland Software Corporation, 100 Enterprise Way, Scotts Valley, Calif. 95066-3249. The CaliberRM program may be used, for example, to capture information related to the work performed as part of the risk management process for medical devices as indicated by ISO 14971.

FIG. 7 depicts a GUI display image 89 which includes a link 90 to a Risk Management and Hazards (RMH) region. Typically, a hazard may have one or more causes. In the GUI display image 89, this is illustrated hierarchically on the left-hand side of the image. That is, a hazard item exists at a parent level and may be associated with one or more cause items which exist at a child level with respect to the hazard item.

The RMH region is illustrated on the right-hand side of the GUI display image 89, and consists of a tabbed area. Selection by a user 2 (FIG. 1) of an item in the hierarchical list on the left-hand side of the GUI display image 89, illustrated by highlighting the selected item, causes the tabbed area on the right-hand side to display details about the selected item. A plurality of data entry fields in the RMH region of the GUI display image 89 allow a user 2 to enter or update data related to the selected item. Such data entry fields typically include a label component and a corresponding data entry component, such as check boxes 91, 116 and 124, text entry boxes, selection boxes, and so forth.

For example, a “Cause” data entry field 95 enables a user 2 (FIG. 1) to indicate whether the highlighted element is a hazard or a cause by checking or unchecking the check box data entry component 91. Other data entry fields enable the user 2 to enter corresponding information: a “Comment/Reason for Action” data entry field 97; an “Initial Hazard/Cause Probability” data entry field 108; an “Initial Hazard Severity” data entry field 111; a “Mitigation Required” data entry field 114; a “Residual Hazard/Cause Probability” data entry field 117; a “Residual Hazard Severity” data entry field 120; an “Affected Entity Type” data entry field 99; and a “Signoff” data entry field 123. As the requirements team discovers hazards and their causes, team members are able to initiate and maintain updated documentation of a cause (the cause being the child of a hazard) by checking the cause check box 91 and entering information about the cause in the other data entry fields.

The various data fields appearing within GUI 89 correspond to cause attributes which are definable by the user 2 (FIG. 1). In general, an attribute is specified by a name, and a description, and possibly by other data describing the attribute, termed metadata, such as a default value or data type (i.e. number, text, Boolean, etc.).

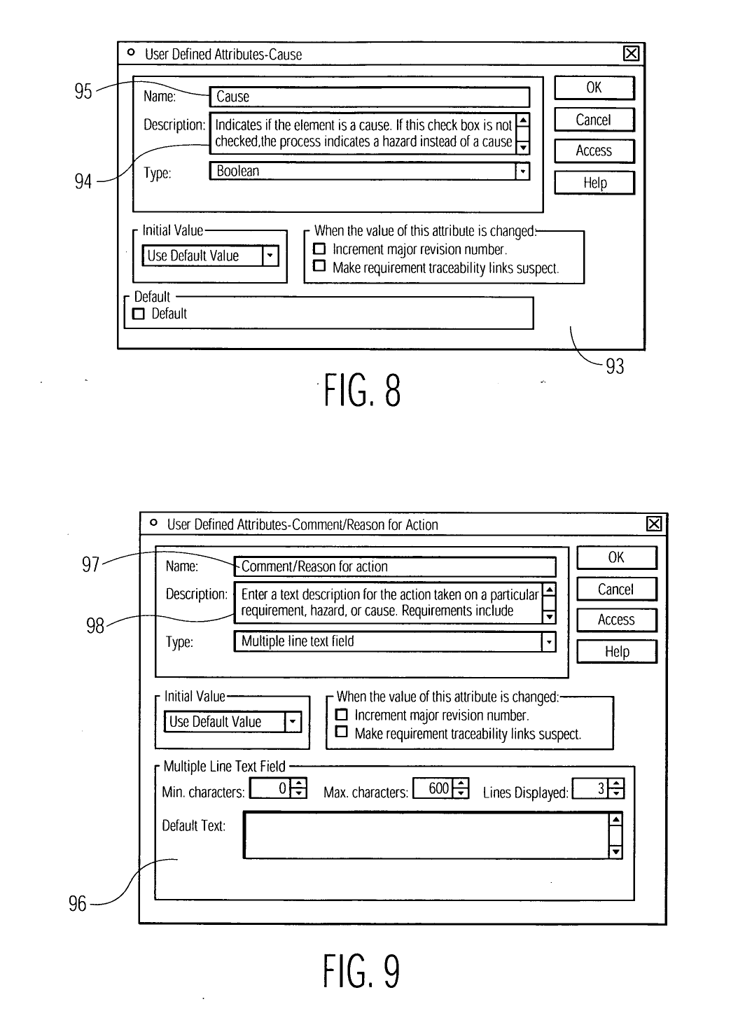

A GUI 93 depicted in FIG. 8 permits a user 2 (FIG. 1) to define an attribute. More specifically, in the illustrated embodiment, the data illustrated in the GUI 93 of FIG. 8 defines the “Cause” attribute corresponding to the “Cause” data entry field 95 in the GUI 89 (FIG. 7). The “Cause” data entry field 95 permits the user 2 to distinguish between hierarchical elements related to a hazard and those related to its associated causes, as described above. In FIG. 8, a cause attribute is defined by entry of “Cause” in the ‘Name’ text box 95. The text in the ‘Description’ text box 94 indicates that if the value of the “Cause” attribute is ‘checked’, then the element is a cause, and if the value is ‘not checked’, the element is a hazard. This may be used to guide the user in supplying data for this data entry field. Metadata for the “Cause” attribute include specification of a Boolean data type, resulting in a check box data entry field 95 and a default value of ‘unchecked’.

The GUI 96 depicted in FIG. 9 permits a user 2 (FIG. 1) to define the “Comment/Reason for Action” attribute corresponding to the “Comment/Reason for Action” data entry field 97 (FIG. 7). The “Comment/Reason for Action” data entry field 97 permits the user 2 to indicate additional information associated with the “Cause” attribute 95 (FIG. 8). In a similar manner to that described above for FIG. 8, the text in the ‘Description’ text box 98 may be used to guide the user in supplying data for this data entry field and indicates that the user may enter a text description for the action to be taken on the corresponding requirement, hazard or cause. Further description may be supplied. The data type of this attribute is defined as a “Multiple line text field”, which allows the user 2 to enter textual information. Such information could be, for example, a reason that a hazard having an “as low as reasonably practical” (ALARP) risk rating may require no mitigation, or whatever other additional information regarding a hazard and/or cause that the user 2 deems appropriate.

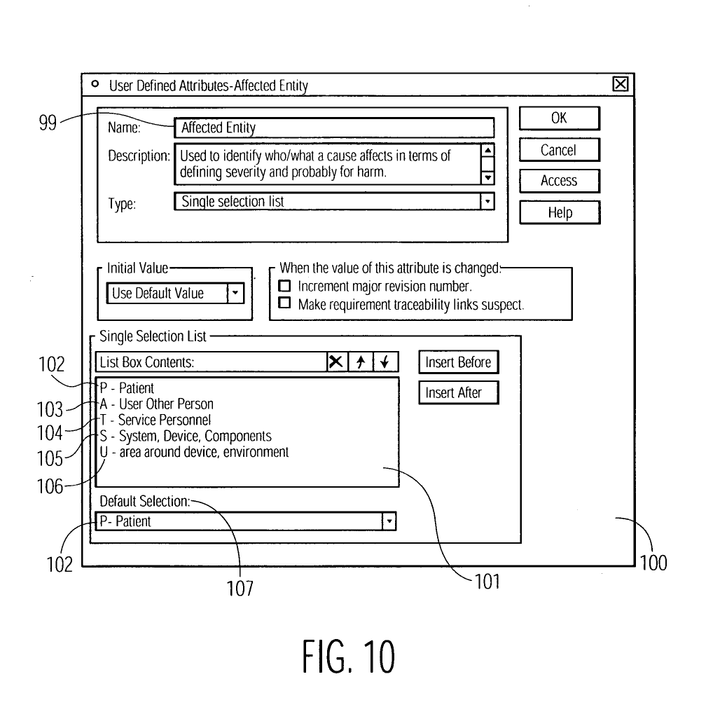

Referring to FIG. 10, a user 2 (FIG. 1) is able to define the “Affected Entity” attribute, corresponding to the “Affected Entity” data entry field 99 (FIG. 7), by means of GUI 100. In FIG. 10, the type of the “Affected Entity” attribute is defined as a single selection list. This enables a user to select a single value from a predefined list of values. The field 101 allows the user 2 to define the list of permitted values for an affected entity, such as, for example, a patient 102, a user or other persons 103, service personnel 104, system devices and components 105 and the environment 106. The default selection is specified in field 107 which, in this example, is a ‘patient’ 102.

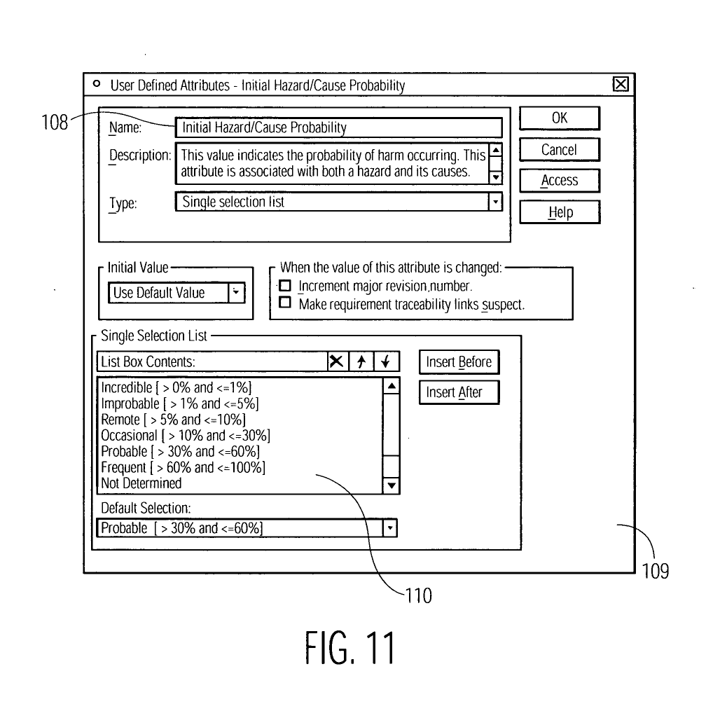

The “Initial Hazard/Cause Probability” attribute, corresponding to the “Initial Hazard/Cause Probability” data entry field 108 (FIG. 7), is defined in GUI 109 illustrated in FIG. 11. The “Initial Hazard/Cause Probability” attribute 108 is also a ‘Single selection list’ type, and the items in the list of permitted values, shown in text box 110, represent respective ranges of probability. Using the GUI 89 (FIG. 7), a user 2 (FIG. 1) uses the “Initial Hazard/Cause Probability” data entry field 108 to select an appropriate probability range value for each cause 95 during the initial hazard analysis and prior to any mitigation activity. Hazard analysis may be performed using the FTA 68 and/or FMEA 62 (FIG. 5 and FIG. 6) approaches, though any such approach may be used. The respective causes 95 have individual hazard probabilities, entered into the corresponding data entry fields 108 (FIG. 7), which contribute to the overall probability assigned to the parent hazard. The hazard has a probability that is at least equal to the highest probability present among the various causes 95 associated with that hazard.

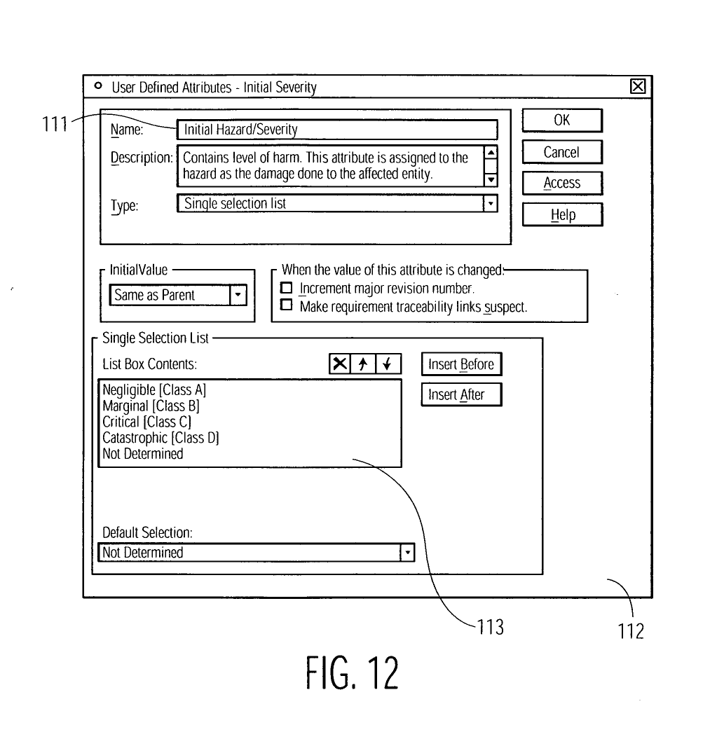

A user 2 (FIG. 1) may assign an initial hazard severity (i.e. prior to any mitigation) in the “Initial Hazard Severity” data entry field 111 (FIG. 7) during the initial hazard analysis. The “Initial Hazard Severity” attribute, corresponding to the “Initial Hazard Severity” data entry field 111, is defined by means of the GUI 112 depicted in FIG. 12. The “Initial Hazard Severity” 111 is also defined as a ‘Single selection list’, and the list of values in text box 113 are ranges of severity. In general, the hazard severity 111 is a property of the hazard itself. The user 2 can decide if having control over assigning a value to the severity of a cause 95 is desirable. Individual values may be selected from the field 113. If a cause 95 appears to have a disproportionate value of severity, the user 2 may have discovered a different hazard.

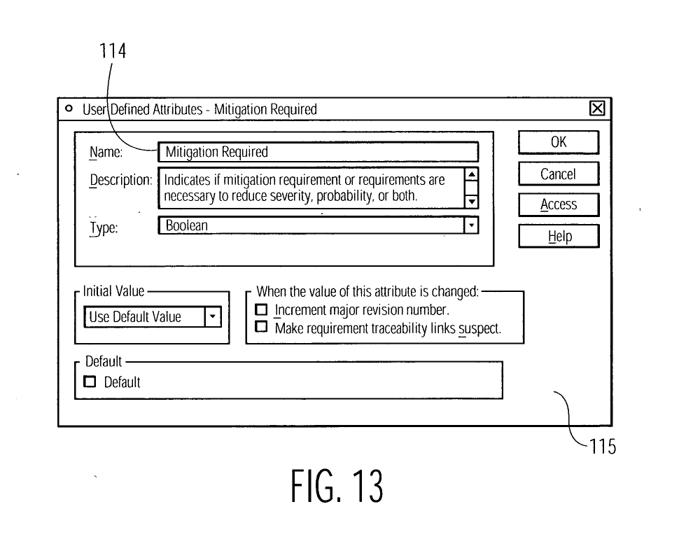

FIG. 13 depicts a GUI 115 that permits a user 2 (FIG. 1) to define a “Mitigation Required” attribute, corresponding to the “Mitigation Required” data entry field 114 (FIG. 7). The “Mitigation Required” attribute is defined as a ‘Boolean’ type, and is represented by a check box 116 in FIG. 7. The “Mitigation Required” data entry field may be used by the user to indicate whether mitigation is required, and/or whether modifications to the design are required to reduce the severity and/or probability of the hazard.

Once an initial severity and probability is assigned to a hazard and/or cause via the data entry fields 111 and 108 (FIG. 7), respectively, a user 2 (FIG. 1) may consult a risk matrix to determine the level of risk represented by the severity and probability. For example, the risk may be one of: intolerable, as low as reasonably practical (ALARP), or broadly acceptable. Intolerable risk requires some action; ALARP risk may, under some circumstances, require action; and acceptable risk typically requires no action. By checking the “Mitigation Required” checkbox 116, the user 2 indicates that mitigation of the hazard is necessary in order to reduce the risk. Typically the user 2 proposes a recommended mitigation for a cause or causes 95 that are creating the intolerable or ALARP risk situation. The user 2 thereby creates a trace from the cause 95 to the mitigation requirements.

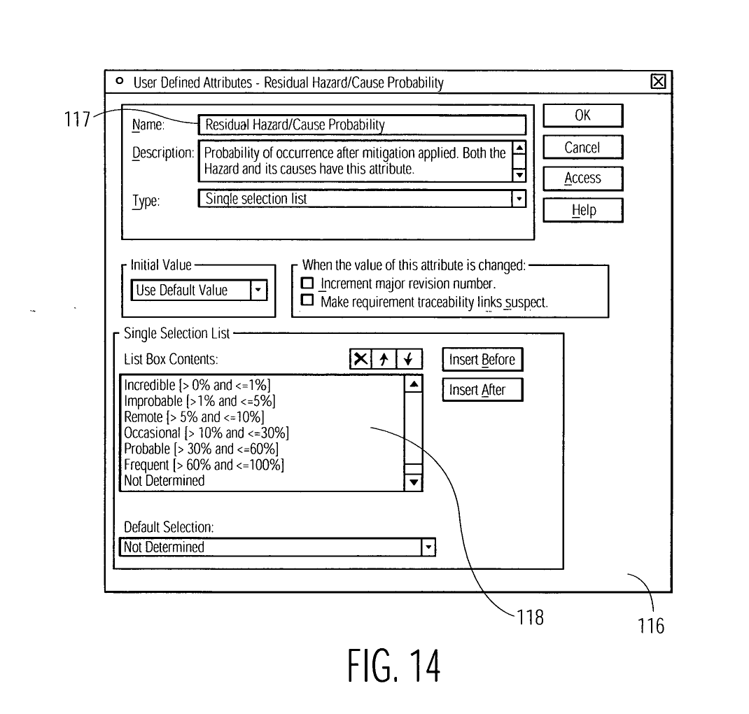

The user 2 (FIG. 1) also performs an analysis to assess the residual severity and probability of a hazard and/or cause assuming that specified mitigation or mitigations are performed. FIG. 14 illustrates a GUI 116 that permits the user 2 to define a “Residual Hazard/Cause Probability” attribute corresponding to the “Residual Hazard/Cause Probability” data entry field 117 (FIG. 7). The “Residual Hazard/Cause Probability” attribute is a ‘single selection list’ attribute. A list of permitted selections is illustrated in text box 118. Using the appropriate risk analysis, i.e. FTA 68 or FMEA 62 (FIG. 5 and FIG. 6), the user 2 determines probabilities for causes 95 assuming they have been mitigated. The user 2 assigns a residual probability for the associated hazard and/or cause by selecting, in data entry field 117, one of the entries in the list of permitted selections in text box 118.

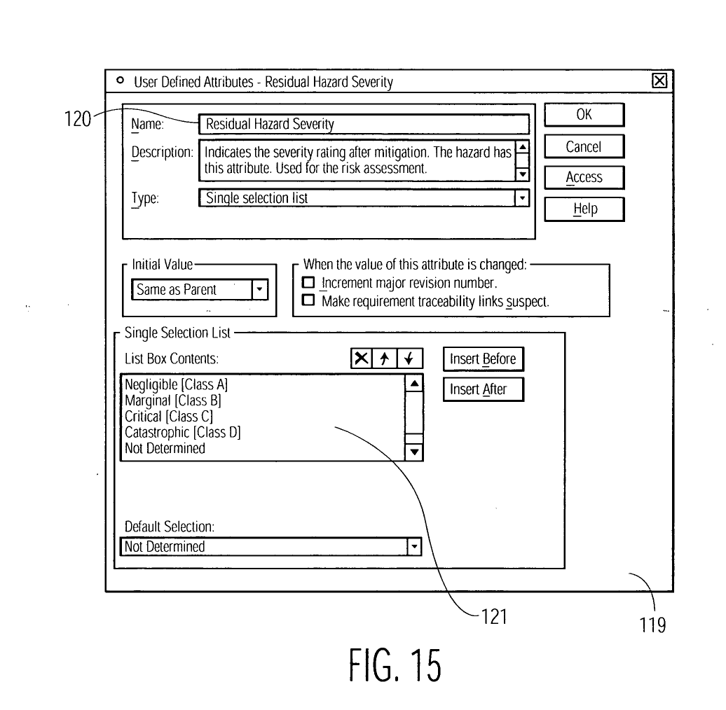

As part of the FTA 68 or FMEA 62 analysis conducted after mitigation 71 (FIG. 5), a “Residual Hazard Severity” is calculated for the hazard and/or its causes. The GUI 119 depicted in FIG. 15 permits a user 2 (FIG. 1) to define a “Residual Hazard Severity” attribute corresponding to the “Residual Hazard Severity” data entry field 120 (FIG. 7). The “Residual Hazard Severity” value is defined as a ‘single selection list’ and the permitted severity values are defined in the text box 121. The user 2 may, via the “Residual Hazard Severity” data entry field 120, associate a residual severity with the associated hazard and/or cause, by selecting one of the entries in the list of permitted selections in text box 121. The user 2 reassesses the risk matrix to ensure that the risk level has indeed been sufficiently reduced, or if not, to determine if additional corrective action is required.

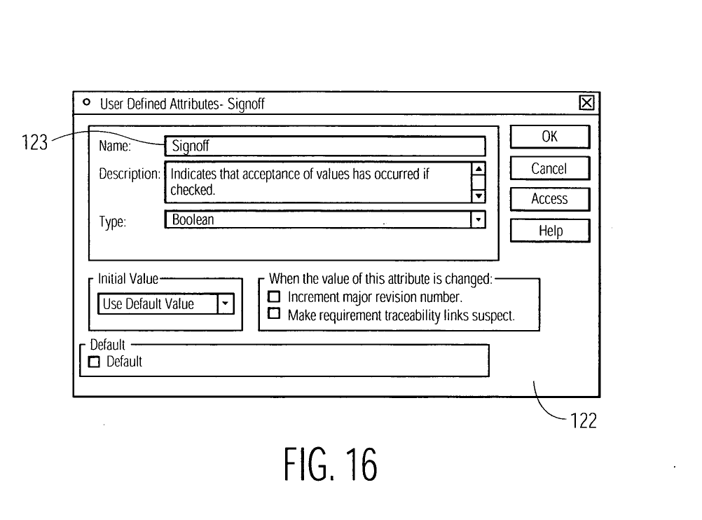

As described above, an identifiable individual has a degree of responsibility for insuring that hazards and/or causes marked for mitigation have actually been mitigated. The GUI 122 illustrated in FIG. 16 defines a “Signoff” attribute corresponding to the “Signoff” data entry field 123 (FIG. 7). The “Signoff” attribute is a Boolean type, whose value is represented by the check box 124 (FIG. 7). This permits the responsible individual to indicate that the specified mitigation or mitigations have been performed by checking the check box 124. A check indicates that this individual has signed off. Checking the signoff check box 124 is a positive indication that acceptance of the existing risk assessment values has occurred.

The attributes, and corresponding data entry fields in FIG. 7, described above provide information about the hazards and corresponding causes identified during the risk management process. Other attributes related to this process may also be defined, and data gathered via associated data entry fields.

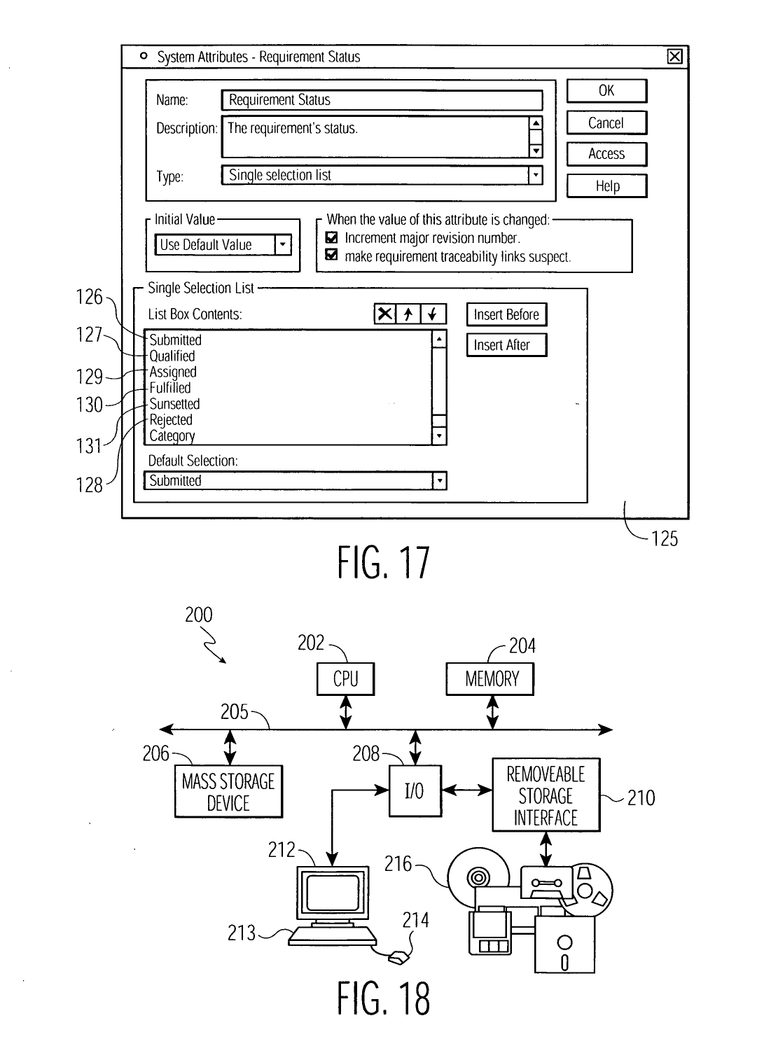

For example, as has already been discussed, each product or project has a lifecycle start 9 and a lifecycle end 11 (FIG. 2). A “Requirement Status” attribute, and a corresponding “Requirement Status” data entry field (not shown), may indicate the state of the risk management process as it progresses through analysis. The GUI 125 illustrated in FIG. 17 allows a user 2 (FIG. 1) to define the “Requirement Status” attribute. The “Requirement Status” attribute is defined as a single selection list attribute, and the values in the text box indicate the states that the risk management process may be in: ‘Submitted’ 126, ‘Qualified’ 127, ‘Assigned’ 129, ‘Fulfilled’ 130, ‘Sunsetted’ 131, ‘Rejected’ 128 and so forth. As the risk management process progresses through it states, a user 2 updates the “Requirement Status” via the corresponding data entry field.

In general, the risk management process begins at the ‘Submitted’ state 126 because someone has submitted an SRQ requesting initiation of the hazard evaluation process. The hazard evaluation process moves to a ‘Qualified’ state 127 once peer review has taken place. If a hazard or cause is deemed to be irrelevant, that hazard is assigned the ‘Rejected’ state 128. An ‘Assigned’ state 129 indicates that the hazard and its causes are allocated to a particular release of a system. In this case the FTA 68 and/or the FMEA 62 analyses are completed for the initial assessment of severity and probability. After the signoff attribute 123 is checked and validation has taken place, the status is moved to the ‘Fulfilled’ state 130. When a system is withdrawn from distribution, or ‘Sunsetted’, the status for its related hazards and causes may by listed as having a ‘Sunsetted’ state 131. Other states may be defined, and used to indicate the status of the risk assessment process.

Other attributes, such as the names of responsible individuals (e.g. the individual responsible for signing off that the required mitigation or mitigations have been performed, as indicated by the data entry field 123); the actual initial and residual risk level (intolerable, as low as reasonably practical (ALARP), or broadly acceptable); and so forth, may also be defined and corresponding data entry fields placed in the GUI 89 of FIG. 7.

The data entry fields in the aforementioned GUIs 89 (FIG. 7) may be accessed in the project life cycle phases described above. In addition, other attributes and corresponding data entry fields may be defined by the user 2 (FIG. 1) using GUIs similar to the GUIs 93, 96, 100, 109, 112, 115, 116, 119 and 122 described above. For example, in the concept phase 29, the requirements team may create features for the target system. The team may enlist the assistance of subject matter experts and other analysts such as hazard, compliance, and regulatory analysts to perform the risk management process that covers hazards and their causes. The general analysis techniques are FMEA 62 or FTA 68. As part of the hazard analysis, the team might contact a system architect to create an architecture that contains the hazards and their causes 95.

Referring to FIG. 7, as the team uncovers hazards and their causes, the team members document that information in using the system described above. For the respective causes, the user 2 checks the “Cause” box 91, choose the “Affected Entity Type” 99, and select the “Initial Hazard Severity” 111. The team can select the “Initial Hazard/Cause Probability” 108. Typically the hazard is assigned the probability as determined through FTA 68 or FMEA 62. The hazard severity is the worst case scenario resulting from the simultaneous occurrence of its causes. As the causes and their hazards are assessed, the team can determine if a cause 95 does or does not require mitigation. The team can use the “Comment/Reason for Action” field 97 to document a choice of non-mitigation or a finding that no mitigation is necessary. If a feature is developed for the purpose of mitigation, the causes requiring mitigation can be traced to that feature. Otherwise, the team can create the requirements to mitigate causes in the elaboration phase 30 (FIG. 3).

The risk management system described above may be implemented on a computer system 200 as illustrated in FIG. 18. The computer system 200 includes a central processing unit (CPU) 202, a memory 204, a mass storage device 206, and an input/output interface 208 coupled together by a computer bus 205. The input/output (I/O) interface 208 is coupled to a user interface consisting of a monitor 212, a keyboard 213 and a pointing device, which in the illustrated embodiment is a mouse 214. The I/O interface 208 is also coupled to a removable storage interface 210 capable of retrieving data from or storing data on one or more tangible storage media. The tangible storage media 216 may include magnetic devices such as reel-to-reel computer tape, cassette tapes, and magnetic disk media such as floppy disks and so forth. The tangible storage media 216 may also include optical devices, such as digital video disk (DVD) or compact disk (CD) and so forth. One skilled in the art understands that any such portable tangible storage media may be used, such as portable storage devices including semiconductor memory integrated circuits. The I/O interface 208 may also be coupled to other peripheral devices (not shown) such as printers for generating reports 8 (FIG. 1) or communications devices (not shown) for communicating with remote systems, local area networks (LANs) or wide area networks (WANs) such as the internet.

In operation, the CPU 202 includes a processor which executes the machine readable instructions forming an executable application and/or executable procedures. Those machine readable instructions are stored in the memory 204, which may consist of read-only memory (ROM) and/or read/write memory (RAM). The CPU 202 retrieves the machine readable instructions from the memory 204 and executes them to perform the operations of the risk management system, as described above.

In the illustrated embodiment, the I/O processor 208 includes a display processor which, in response to commands from the CPU 202, generates signals representing the GUI display images described above in FIG. 7 to FIG. 17 and supplies those image representative signals to the monitor 212 which displays the images. The I/O processor 208 also receives user 2 (FIG. 1) commands and data from the keyboard 213 and/or mouse 214 and provides that information to the CPU 202. The CPU 202 responds to the received user 2 commands and data to control the operation of the risk management system as described above.

Data may be retrieved from and stored in the mass storage device 206. For example, the mass storage device 206 may provide storage for the one or more repositories of information, such as the hazard association repository 4 and the detailed requirement repository 7 (FIG. 1). The mass storage device 206 may also store the machine readable instructions forming the executable application and/or executable procedures. The CPU 202 may retrieve the executable application and/or executable procedures from the mass storage device 206 and store them in the memory 204. The CPU 202 may then retrieve the machine readable instructions from the memory 204 and execute the executable application and/or executable procedures to perform the risk management activities described above.

Data may also be retrieved from and stored in tangible storage media 216 via the removable storage interface 210. Any data may be stored in and/or retrieved from the tangible storage media. More specifically, in the illustrated embodiment, the machine readable instructions in the executable application and/or executable procedures forming the risk management system may be stored in a tangible storage medium. The CPU 202 may condition the I/O processor 208 to retrieve the executable application and/or executable procedures from the appropriate tangible storage medium via the removable storage interface 210, and to store the executable application and/or executable procedures in the mass storage device 206 and/or the memory 204. The CPU 202 may then execute the executable application and/or executable procedures in the memory 204 to perform the risk management activities described above.

What is claimed is:

1. A system for managing risk, comprising:
a user interface enabling selection of a particular affected entity from a plurality of predetermined types of affected entity, in response to user command;
at least one repository including information associating a selected affected entity with a particular hazard potentially adversely affecting said selected affected entity, said at least one repository associating said particular hazard with:
a severity of said particular hazard,
at least one cause of said particular hazard, and
a probability of occurrence of said at least one cause; and
a risk processor for using information in said at least one repository to provide an indication of risk of said particular hazard to said selected affected entity.

2. A system according to claim 1, wherein said at least one repository further associates with said particular hazard a probability of occurrence based on the at least one cause of said particular hazard and said probability of occurrence of said at least one cause.

3. A system according to claim 1, further comprising a tangible storage medium including machine readable instructions for performing risk management activities.

4. A system according to claim 1, wherein said predetermined types of affected entity comprise two or more of, (a) a project, (b) a product, (c) a market, (d) a product feature, (e) a set of product features and (f) a patient environment.

5. A system according to claim 1, wherein said at least one repository includes information associating, with said particular hazard, an indication identifying mitigation is necessary for said particular hazard.

6. A system according to claim 5, wherein said at least one repository includes information associating, with said particular hazard, at least one test for use in verifying said particular hazard has been mitigated.

7. A system according to claim 5, wherein said at least one repository includes information associating, with said particular hazard, a residual severity remaining after hazard mitigation.

8. A system according to claim 5, wherein said at least one repository includes information associating, with said particular hazard, an indication identifying said particular hazard has been mitigated and identifying a responsible person accepting said mitigation.

9. A system according to claim 1, further comprising an audit processor for monitoring access to said at least one repository and for recording data indicating, information accessed and identifying a user initiating access.

10. A system according to claim 1, further comprising an audit processor for monitoring access to said at least one repository and for recording data indicating, modifications to stored information and a source processing device originating messages initiating said modifications.

11. A system according to claim 1, wherein:
said at least one repository includes information associating a selected affected entity with a plurality of hazards potentially adversely affecting said selected affected entity, said at least one repository associating individual hazards of said plurality of hazards with:
a severity of an individual hazard,
at lease one cause of said individual hazard and
a probability of occurrence of said at least one cause of said individual hazard; and
said risk processor uses information in said at least one repository to provide indications of risk of said individual hazards to said affected entity.

12. A system according to claim 11, wherein said risk processor ranks said individual hazards according to said indications of risk.

13. A method for managing risk, comprising the activities of:
receiving data identifying a selection of a particular affected entity from a plurality of predetermined types of affected entity, in response to user command;
accessing at least one repository including information associating a selected affected entity with a particular hazard potentially adversely affecting said selected affected entity, said at least one repository associating said particular hazard with:
a severity of said particular hazard,
at lease one cause of said particular hazard, and
a probability of occurrence of said at least one cause; and
using information retrieved from said at least one repository to provide an indication of risk of said particular hazard to said affected entity.

14. The method according to claim 13, wherein said at least one repository further associates with said particular hazard a probability of occurrence based on the at least one cause of said particular hazard and said probability of occurrence of said at least one cause.

15. The method according to claim 13, further comprising the activity of providing a tangible storage medium including machine readable instructions for performing risk management activities.

16. The method according to claim 13, further comprising the activity of creating a set of predetermined types of affected entity including at least two of (a) a project, (b) a product, (c) a market, (d) a product feature, (e) a set of product features and (f) a patient environment.

17. The method according to claim 13, further comprising the activity of including within said at least one repository information associating, with said particular hazard, an indication that mitigation is necessary for said particular hazard.

18. The method according to claim 17, further comprising the activity of including within said at least one repository information associating, with said particular hazard, a residual severity remaining after hazard mitigation.

19. The method according to claim 17, further comprising the activity of including within said at least one repository information associating, with said particular hazard, an indication identifying that said particular hazard has been mitigated and identifying a responsible person accepting said mitigation.

20. The method according to claim 13, further comprising the activity of monitoring access to said at least one repository and for recording data indicating, information accessed and identifying a user initiating access.

21. The method according to claim 13, further comprising the activity of monitoring access to said at least one repository and for recording data indicating, modifications to stored information and a source processing device originating messages initiating said modifications.

22. The method according to claim 13, further comprising the activity of including within said at least one repository information associating, with said particular hazard, a test for use in verifying that said particular hazard has been mitigated.

23. The method according to claim 13, further comprising the activities of:
creating a set of project management phases including at least two of: (a) preconcept; (b) concept; (c) elaboration and (d) testing; and
using information retrieved from said at least one repository to provide an indication of risk of said particular hazard to said affected entity during at least two project management phases.

24. A tangible storage medium for storing machine readable instructions for performing the activities of:
receiving data identifying a selection of a particular affected entity from a plurality of predetermined types of affected entity, in response to user command;
accessing at least one repository including information associating a selected affected entity with a particular hazard potentially adversely affecting said selected affected entity, said at least one repository associating said particular hazard with,
a severity of said particular hazard,
at lease one cause of said particular hazard and
a probability of occurrence of said at least one cause; and
using information retrieved from said at least one repository to provide an indication of risk of said particular hazard to said affected entity.
